(19) United States
(12) Patent Application Publication
(10) Pub. No.: US 2009/0002428 A1
(43) Pub. Date: Jan. 1, 2009

(54) METHOD OF DETECTING MISSING NOZZLE AND INK JET PRINT HEAD USING THE SAME

(75) Inventor: Jae Sik MIN, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/060,983

(22) Filed: Apr. 2, 2008

(30) Foreign Application Priority Data
Jun. 29, 2007 (KR) 2007-65438

(51) Int. Cl. B41J 29/393

(52) U.S. Cl. 347/19

(57) ABSTRACT

A method of detecting a missing nozzle and an ink jet print head using the same can detect a missing nozzle immediately with a simple process when the missing nozzle is generated. One method of detecting a missing nozzle used in an ink jet print head provided with plural chambers, plural heaters corresponding to the chambers, and plural nozzles corresponding to the heaters can include detecting a temperature of each of the chambers, and when the detected temperature deviates from a predetermined temperature range, determining that a nozzle corresponding to the chamber is a missing nozzle.

### CROSS-REFERENCE TO RELATED APPLICATIONS

This application claims the benefit of Korean Patent Application No. 2007-0065438, filed on Jun. 29, 2007 in the Korean Intellectual Property Office, the disclosure of which is incorporated herein by reference in its entirety.

### BACKGROUND OF THE INVENTION

1. Field of the Invention

The present general inventive concept relates to an image forming apparatus and a method of detecting a missing nozzle and an ink jet print head using the same, and more particularly, to a method of detecting a missing nozzle and an ink jet print head using the same which can detect a missing nozzle by measuring temperatures of respective nozzles provided in an ink jet print head.

2. Description of the Related Art

An ink jet print head is a device that forms an image by ejecting ink droplets onto a desired position on a printing medium.

The ink jet print head is generally classified as an electro-thermal type or a piezoelectric type according to the ink droplet ejection mechanism. The electro-thermal type print head generates bubbles in the ink using a heat source and ejects the ink droplets by the expansive power of the bubbles.

The electro-thermal type print head generally can include a substrate that is configured as a silicon wafer, an ink supply hole that is formed on the substrate to supply an ink, a flow channel layer to form a flow channel and plural chambers on the substrate, a nozzle layer disposed on the flow channel layer and may have plural nozzles corresponding to the ink chambers, and plural heaters corresponding to the ink chambers to heat the ink in the ink chambers.

In the ink jet print head, if any part of the plural nozzles is clogged or damaged when any part of the heaters or the actuators corresponding to the respective nozzles works improperly, or a circuit applying electric power to the heaters or the actuators malfunctions, white lines may be formed on the printing medium, which can result in deterioration of a printing quality.

A nozzle, which is damaged and cannot eject ink, is called a missing nozzle. A technique for detecting the missing nozzle and compensating for the missing nozzle to prevent the deterioration of a printing quality has been developed.

An example of methods for detecting the missing nozzle is disclosed in Korean Patent Registration No. 10-636236. The disclosed method is to detect the missing nozzle by scanning a result printed in a printing unit.

In other words, the conventional method includes printing a test pattern by ejecting the ink onto the printing medium through the nozzles, and scanning the test pattern using a scan sensor to detect the missing nozzle.

However, the conventional method for detecting the missing nozzle is troublesome and complicated because of performing the processes of printing the test pattern and seeking out the missing nozzle through the scanning.

Further, the conventional detecting technique seeks out the missing nozzle by periodic testing (e.g., repeating the printing of the test pattern at a regular interval) after actually printing for a predetermined amount (e.g., time). However, when the missing nozzle is generated right after the missing nozzle detecting process, an image of a low quality is obtained until the next missing nozzle detecting process. In other words, the conventional detecting technique cannot detect the missing nozzle immediately when the missing nozzle is generated.

Still further, the conventional missing nozzle detection wastes ink. Namely, since it is necessary to eject the ink onto the printing medium in the missing nozzle detecting process, the printing medium or the ink is unnecessarily consumed.

Still further, because the position information of the missing nozzle is detected using the scan sensor, it is difficult to detect the position of the missing nozzle accurately.

Japanese Patent Laid-Open Publication No. H05-309832 discloses an ink jet recording head which detects a temperature of a print head, and determines whether ink ejection of the print head is performed well or not, according to the detected temperature.

However, the disclosed ink jet recording head detects whether the ink is ejected well or not, only by measuring an average temperature of the head, but does not measure individual temperatures of the respective ink chambers. Thus, the respective missing nozzles which generate white lines are not detected accurately.

### SUMMARY OF THE INVENTION

The present general inventive concept provides a method for detecting a missing nozzle or a malfunctioning nozzle, an ink jet print head using the same and an image forming apparatus that can detect a missing nozzle (e.g., immediately) when the missing nozzle is generated.

The present general inventive concept also provides a method of detecting a missing nozzle or a malfunctioning nozzle, an ink jet print head and an image forming apparatus using the same that can use or measure temperatures corresponding to a plurality of nozzles.

The present general inventive concept also provides a method of detecting a missing nozzle or a malfunctioning nozzle, an ink jet print head and an image forming apparatus using the same that can detect a missing nozzle by measuring temperatures of respective nozzles provided in an ink jet print head.

The present general inventive concept also provides a method of detecting a missing nozzle and an ink jet print head using the same that can detect an accurate position of the missing nozzle.

Additional aspects and/or utilities of the present general inventive concept will be set forth in part in the description which follows and, in part, will be obvious from the description, or may be learned by practice of the present general inventive concept.

The foregoing and/or other aspects and utilities of the present general inventive concept may be achieved by providing a method of detecting a missing nozzle used in an ink jet print head provided with plural chambers, plural heaters corresponding to the chambers, and plural nozzles corresponding to the heaters, including detecting a temperature of each of the chambers, and when the detected temperature deviates from a predetermined temperature range, determining that the nozzle corresponding to the chamber is a missing nozzle.

The detecting may use a thin film thermocouple adjacent each of the chambers.

The predetermined temperature range may be from 40° C. to 80° C.

The detecting may be performed to detect a temperature of each of the chambers when the heaters are turned on.

The foregoing and/or other aspects and utilities of the present general inventive concept may also be achieved by providing an ink jet print head including a substrate formed with heaters and a passivation layer protecting the heaters, a flow channel layer to define chambers corresponding to the heaters, a nozzle layer formed with nozzles corresponding to the chambers, temperature sensing parts to detect temperatures of the respective chambers, and a control part to determine whether a missing nozzle is generated. When a temperature detected by a temperature sensing part deviates from a predetermined temperature range, the control part may determine that a corresponding nozzle is a missing nozzle.

The flow channel layer may provide restrictors to guide the ink to the chambers, and the temperature sensing parts may be provided in the restrictors.

The temperature sensing parts may be provided between the passivation layer and the flow channel layer and adjacent to the chambers.

The temperature sensing parts may be configured as a thin film thermocouple.

The foregoing and/or other aspects and utilities of the present general inventive concept may also be achieved by providing an ink jet print head including plural nozzle modules that include chambers to hold ink, nozzles corresponding to the chambers, and heaters to heat the ink in the chambers, temperature sensing parts that are provided in the respective nozzle modules to detect temperatures of the chambers, and a control part to determine whether a missing nozzle is generated. When the detected temperature of the chamber deviates from a bubble generating temperature range of the ink, the control part may determine that the nozzle of the corresponding nozzle module is a missing nozzle.

The temperature sensing parts may be configured as a thin film thermocouple.

The control part may control an on/off state of the heaters, and the temperature sensing parts may detect the temperatures of the chambers when the heaters are turned on.

The foregoing and/or other aspects and utilities of the present general inventive concept may also be achieved by providing a method of detecting a missing nozzle used in an ink jet print head, the method including measuring temperatures of each of a plurality of individual chambers of the ink jet print head separately; and determining when the measured temperatures are out of a prescribed range.

The foregoing and/or other aspects and utilities of the present general inventive concept may also be achieved by providing a method of detecting a missing nozzle used in an ink jet print head, the method including detecting a single malfunctioning nozzle of a ink jet print head configured with a plurality of nozzles during a printing operation by independently measuring temperatures at a plurality of positions of the ink jet print head.

The foregoing and/or other aspects and utilities of the present general inventive concept may also be achieved by providing an image forming apparatus including an ink jet print head including a plurality of nozzles, a plurality of detect circuits configured to determine temperature at a plurality of positions in the ink jet print head to identify a malfunctioning nozzle.

### BRIEF DESCRIPTION OF THE DRAWINGS

These and/or other aspects and utilities of the exemplary embodiments of the present general inventive concept will become apparent and more readily appreciated from the following description of the embodiments, taken in conjunction with the accompanying drawings, of which:

FIG. 1 is a diagram of plan view schematically illustrating a constitution of an ink jet print head in accordance with an exemplary embodiment of the present general inventive concept;

FIG. 2 is a diagram illustrating a sectional view taken along line I-I in FIG. 1;

FIG. 3 is a diagram of a partial sectional perspective view schematically illustrating a constitution of a nozzle module of the ink jet print head in accordance with an exemplary embodiment of the present general inventive concept;

FIG. 4 is a control block diagram illustrating an ink jet print head in accordance with the present general inventive concept;

FIG. 5 is a diagram a plan view schematically illustrating a constitution of an ink jet print head in accordance with another exemplary embodiment of the present general inventive concept;

FIG. 6 is a diagram of a partial sectional perspective view schematically illustrating a constitution of a nozzle module of the ink jet print head in accordance with another exemplary embodiment of the present general inventive concept; and

FIG. 7 is a diagram illustrating sectional view taken along line A-A in FIG. 6.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below in order to explain the present general inventive concept by referring to the figures.

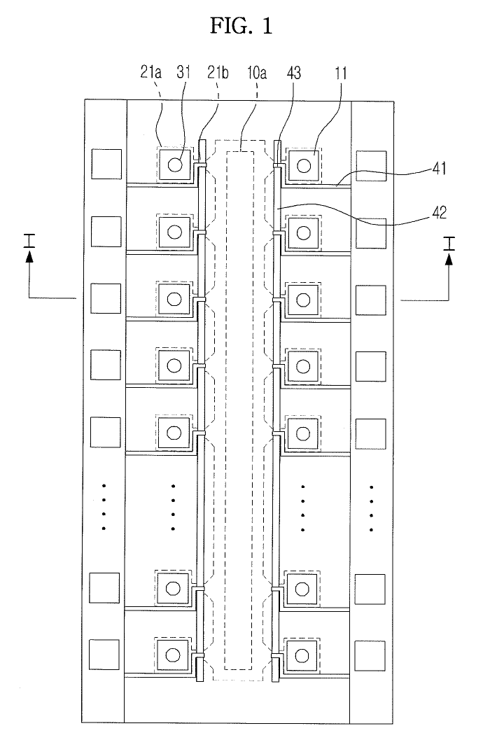

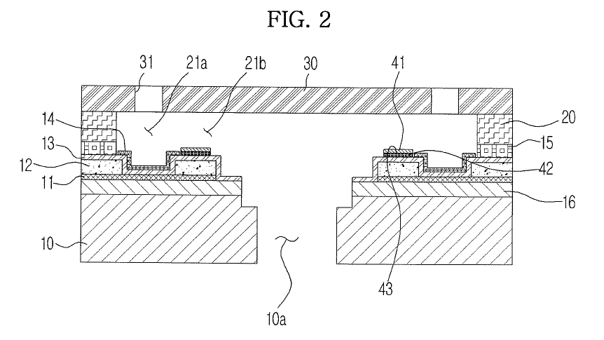

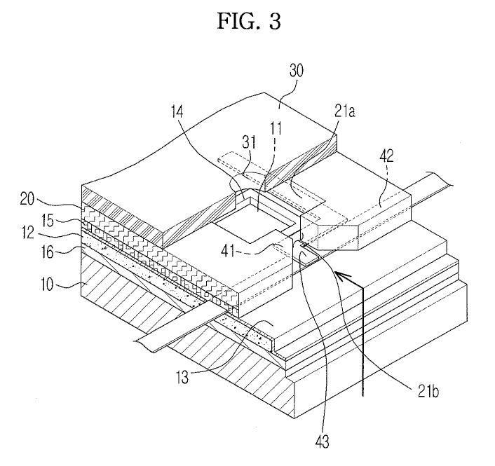

FIG. 1 is a diagram of a plan view schematically diagram illustrating a constitution of an ink jet print head in accordance with an exemplary embodiment of the present general inventive concept, FIG. 2 is a sectional view taken along line I-I in FIG. 1, and FIG. 3 is a partial sectional perspective view schematically showing a constitution of a nozzle module of the ink jet print head in accordance with an exemplary embodiment of the present general inventive concept.

The ink jet print head of the embodiment of FIG. 1 is preferably an electro-thermal type ink jet print head that can generate bubbles in an ink using a heat source and eject ink droplets by an expansive power of the bubbles.

As illustrated in FIGS. 1 to 3, one embodiment of the ink jet print head may include a substrate 10, at which heaters 11 are provided as an ejection pressure generating element for ink ejection, and electrodes 12 formed on the heaters 11. At least one of a passivation layer 13 and an anti-cavitation layer 14 may be additionally formed on the electrodes 12. Also, a flow channel layer 20 to define chambers 21a may be disposed at the substrate 10, and a nozzle layer 30 to form nozzles 31 for ink ejection may be disposed at the flow channel layer 20. The flow channel layer 20 is preferably stably coupled to the substrate 10. A glue layer 15 may be provided between the flow channel layer 20 and the substrate 10 to stably bond the flow channel layer 20 onto the substrate 10. Temperature sensing parts 43 are preferably formed at, near, corresponding to or adjacent the chambers 21a to detect a temperature of the ink corresponding to the nozzles (e.g., in the chambers 21a). For example, the temperature sensing parts 43 may be formed on the passivation layer 13 adjacent to the chambers 21a,

The substrate 10 is preferably configured as a silicon wafer with an ink supply hole 10a through which the ink is supplied from an ink storage part (not shown). The heaters 11 provided on the substrate 10 may be configured as a typical thin film heater or the like to heat the ink in the chambers 21a by converting an electric signal transmitted from the electrodes 12 into a thermal energy. The heaters 11 may be made of a heat resistant material, such as tantalum nitride (TaN) or tantalum-aluminum (Ta—Al). The electrodes 12 are preferably formed by depositing a metal material having a sufficient conductivity, such as aluminum (Al). The deposited metal layers may be formed on the heaters 11 in a predetermined wiring pattern by a photolithography process and an etching process. The electrodes 12 may receive a signal from a typical CMOS logic and a power transistor, and transmit the signal to the heaters 11.

A heat storage layer 16 may be provided between the heaters 11 and the substrate 10 as an insulation layer such as a silicon oxide film. The heat storage layer 16 functions to reduce or prevent the heat generated from the heaters 11 from escaping to the substrate 10.

The passivation layer 13 may protect the heaters 11 and/or the electrodes 12 by preventing the heaters 11 and the electrodes 12 from being oxidized or directly contacting the ink. The passivation layer 13 may be configured as a silicon nitride (SiN) film or the like that has a good insulation property and heat transfer efficiency. The anti-cavitation layer 14 may be provided on the passivation layer 13 above heat generating regions of the heaters 11 corresponding to the nozzles 31.

The anti-cavitation layer 14 may protect the heaters 11 from a cavitation force that is generated when the bubbles in the chambers 21a contract and collapse, and reduce or prevent corrosion of the heaters 11 from the ink. The anti-cavitation layer 14 may be formed by depositing tantalum (Ta) or the like on the passivation layer 13 to a predetermined thickness.

The flow channel layer 20 defines ink passages 21 (e.g., 21a and 21b) that connect the ink supply hole 10a and the nozzles 31. The respective ink passages 21 may include chambers 21a in which the ink is filled and restrictors 21b to connect the ink supply hole 10a and the chambers 21a.

The temperature sensing parts 43 are preferably provided in the restrictors 21b that guide the ink to the chambers 21a to detect the temperature of the ink in the chambers 21a.

According to embodiments of the present general inventive concept, a layer (e.g., feature) is considered as being formed (or provided) “on” another layer or a substrate when formed (or provided) either directly on the referenced layer or the substrate or formed (e.g., provided) on other layers or patterns overlaying the referenced layer.

The temperature sensing part 43 may be configured as a thin film thermocouple. A temperature sensor using a temperature coefficient of resistance (TCR) may be used as a temperature sensor to detect the temperature. However, the temperature sensor using the TCR just detects an average temperature of a relatively broad area because it detects the temperature by using a resistance variation value of a metal, but cannot detect the temperature of a specific point. Accordingly, it is preferred that the present general inventive concept is provided with the temperature sensing part 43 (e.g., using the thermocouple) to precisely detect the temperature of the specific point.

The thermocouple is a temperature sensor in which two different types of metals are arranged in a closed loop, one of two junctions formed between two types of metals contacting each other in the closed loop is connected to a high-temperature side, and the other junction is connected to a low-temperature side. Such a thermocouple uses a Seebeck effect such that an electromotive force is generated according to the kinds of metals in the closed loop and the temperature difference between the two junctions.

In an exemplary embodiment, the thermocouple is structured such that one junction between two types of metals contacting each other is directly coupled to a region, of which a temperature is to be detected, and the other opened (e.g., non-contacted) ends of two respective metals are coupled to a data acquisition board, to obtain a temperature signal. Based on the temperature signal, the thermocouple can conveniently detect the temperature of the desired region. The thermocouple can be classified into various types according to the two kinds of metals making the thermocouple.

Preferably, a k-type thermocouple using chromel and alumel is used in the embodiment of FIG. 1.

To detect the temperature of the ink in the chamber 21a, the temperature sensing part 43 may be formed by connecting one end portion of a first metal layer 41 and one end portion of a second metal layer 42 to each other on the passivation layer 13 that defines a bottom surface of the restrictor 21b.

The first metal layer 41 may be formed by depositing chromel through sputtering or chemical vapor deposition, and patterning the same. Similarly, the second metal layer 42 may be formed by depositing alumel through sputtering or chemical vapor deposition, and patterning the same.

The first and second metal layers 41 and 42 may extend round the chamber 21a and the ends of the first and second metal layers 41 and 42 may be disposed in the restrictor 21b so that the first and second metal layers 41 and 42 can be connected to each other in the restrictor 21b while also reducing or minimizing contact with the ink. However, configuration of the layers 41 and 42 is not intended to be so limited.

The area of the temperature sensing part 43 can be varied by adjusting the widths of the end portions of the first and second metal layers 41 and 42.

The temperature of the ink in the chamber 21a is preferably measured by the temperature sensing part 43. An analog signal of the measured temperature may be converted into a digital signal through an A/D converter (not shown), and the digital signal transmitted to a control part 50 (which will be described later).

An exemplary method of detecting a missing nozzle of the ink jet print head according to an embodiment of the present general inventive concept will now be described. The exemplary method of detecting a missing nozzle of the ink jet print head may be applied to and will be described using the apparatus embodiment of FIG. 1, however, the method embodiment is not intended to be limited thereby.

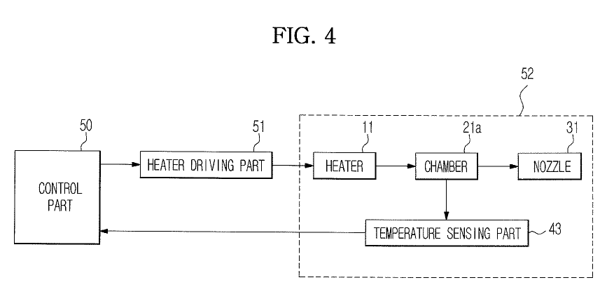

FIG. 4 is a control block diagram of the ink jet print head according to the present general inventive concept. The ink jet print head according to the present general inventive concept may further include a control part 50 and a heater driving part 51.

The control part 50 can drive the heater 11 through the heater driving part 51 according to an input signal.

A unit nozzle module 52 may include the chamber 21a defined by the flow channel layer 20, the heater 11 provided below the chamber 21a, the nozzle 31 provided on the chamber 21a, and the temperature sensing part 43 detecting the temperature of the chamber 21a. A plurality of nozzle modules 52 may be formed in the ink jet print head.

In the nozzle module 52, the bubbles are generated in the ink in the chamber 21a by driving the heater 11, which is controlled by the control part 50. The ink droplets are ejected through the nozzle 31 by the expansive power of the bubbles.

At this time, the temperature sensing part 43 may detect (e.g., continuously) the temperature of the chamber 21a at least when the heater 11 is driven. The temperature signal detected by the temperature sensing part 43 may be transmitted to the control part 50.

When the heater 11 generates heat by the signal of the control part 50 in the normal state or operation, because the heated ink in the chamber 21a is ejected through the nozzle 31, the ink in the chamber 21a is preferably kept in a predetermined temperature range. For example, when the ink is normally ejected through the nozzle 31, the ink in the chamber 21a is preferably kept in a temperature range of about 60° C.±20° C. at which the bubbles are generated in the ink.

If the heater 11 generates heat while the nozzle 31 is clogged, the temperature of the chamber 21a may continuously exceed a prescribed threshold (e.g., high threshold). For example, since the ink in the chamber 21a cannot be ejected through the nozzle 31 and the ink in the chamber 21a is continuously heated by the heater 11, the temperature of the chamber 21a rises continuously over 80° C.

Also, if the heater 11 works improperly and/or does not generate heat, the temperature of the chamber 21a may continuously fall below a prescribed threshold (e.g., low threshold). For example, the chamber 21a may be kept in an ambient temperature when the heater 11 works improperly and/or does not generate heat.

When the missing nozzle occurs (e.g., the nozzle 31 is clogged or the heater 11 does not generate heat), the temperature of the chamber 21a may deviate from the predetermined temperature range (about 60° C.±20° C.). Accordingly, the control part 50 may monitor the temperature of the chamber 21a and determine that the temperature of the chamber 21a deviates from the corresponding temperature range. In this case, the control part 50 preferably determines that the nozzle 31 of the corresponding nozzle module 52 is a missing nozzle.

After detecting the missing nozzle, the deterioration of a printing quality may be reduced or prevented through various missing nozzle compensating methods. A plurality of patents related to the missing nozzle compensating methods have been filed by this applicant, and have been registered. One example of the missing nozzle compensating methods is disclosed in Korean Patent Laid-Open Publication No. 2006-0067056. Since various missing nozzle compensating methods can be adapted to the present general inventive concept, the explanation thereof is omitted here.

According to exemplary method and apparatus embodiments described above, the missing nozzle is preferably detected when performing the printing operation. Thus, the missing nozzle can be found promptly and/or a printing quality increased, when compared to a conventional missing nozzle detecting method using a scanning operation.

Also, a series of complicated processes of the printing and scanning of a conventional missing nozzle detection can be omitted. Accordingly, exemplary embodiments may avoid unnecessary printing operations, which can reduce or prevent a waste of a printing medium or ink.

Also, since exemplary embodiments may determine whether the missing nozzle is generated by measuring the temperature of the respective nozzles, the accurate detection of the missing nozzle can be achieved.

An ink jet print head according to another exemplary embodiment of the present general inventive concept will now be described. The same elements of previous embodiments are denoted by the same reference numerals, and the explanation thereof will be omitted here.

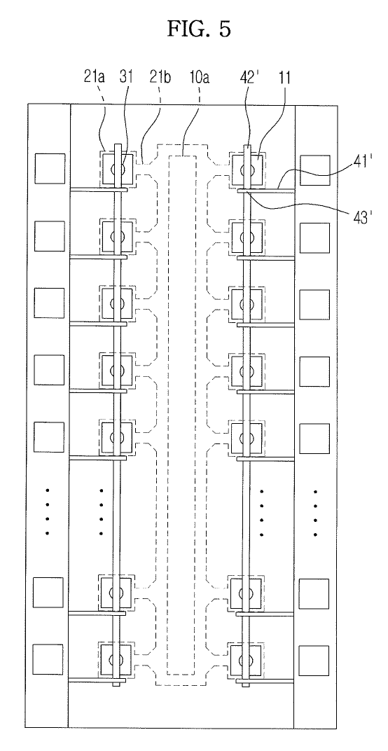

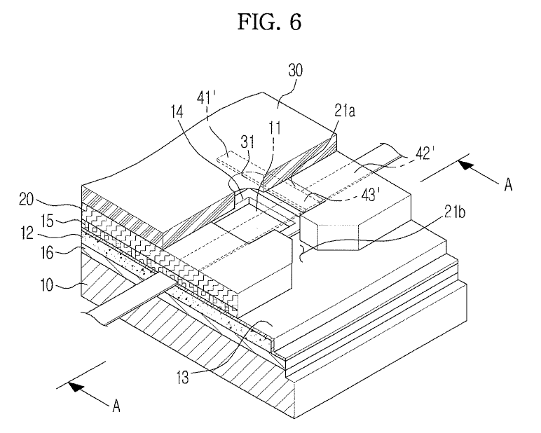

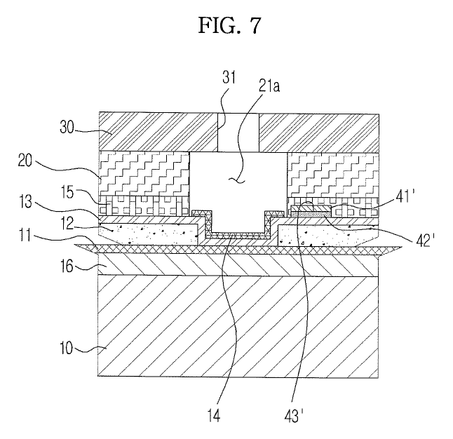

FIG. 5 is a plan view schematically illustrating a constitution of an ink jet print head in accordance with another exemplary embodiment of the present general inventive concept, FIG. 6 is a partial sectional perspective view schematically illustrating a constitution of a nozzle module of the ink jet print head in accordance with another exemplary embodiment of the present general inventive concept, and FIG. 7 is a sectional view taken along line A-A in FIG. 6.

The ink jet print head of the embodiment of FIG. 5 has the same constitution as the ink jet print head of FIG. 1, except for a position of a temperature sensing part.

A temperature sensing part 43′ included in the ink jet print head of the embodiment of FIG. 5 may be provided at the passivation layer 13 such that one end portion of a first metal layer 41′ and one end portion of a second metal layer 42′ may be coupled to each other between the flow channel layer 20 defining the chamber 21a and the passivation layer 13 to measure the temperature of the ink in the chamber 21a.

Preferably, in order to avoid the contact between the ink in the chamber 21a and the temperature sensing part 43′, the temperature sensing part 43′ is deposited on the passivation layer 13 at a distance from the chamber 21a, and then the glue layer 15 and the flow channel layer 20 are deposited in order.

Accordingly, although the ink jet print head of FIG. 5 is used for a long period, the corrosion of the temperature sensing part 43′ due to the contact with the ink can be reduced or prevented.

Exemplary embodiments of processes of detecting the missing nozzle of the ink jet print head using the embodiment of FIG. 5 may be performed identically to a detecting process according to the embodiment of FIG. 1.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

As apparent from the above description, embodiments of methods of detecting a missing nozzle and ink jet print heads that can detect a missing nozzle have various advantages. For example, embodiments according to the present general inventive concept can promptly detect a missing nozzle, and can determine whether an individual missing nozzle is generated using the temperature of the respective nozzles. Further, embodiments can operate when performing the printing operation.

Further, since it is determined whether the missing nozzle is generated by measuring the temperature of the respective nozzles, the accurate detection of the missing nozzle can be achieved.

Still further, the missing nozzle can be detected by a simple process, and unnecessary printing operations are not performed, which can reduce or prevent a waste of a printing medium or an ink. For example, a missing nozzle may be detected independently of an evaluation of a printing medium output by the apparatus containing the print head having the missing nozzle.

Although a few embodiments of the present general inventive concept have been shown and described, it would be appreciated by those skilled in the art that changes may be made in these embodiments without departing from the principles and spirit of the present general inventive concept, the scope of which is defined in the appended claims and their equivalents. As used in this disclosure, the term “preferably” is non-exclusive and means “preferably, but not limited to.” Terms in the claims should be given their broadest interpretation consistent with the general inventive concept as set forth in this description. For example, the terms “coupled” and “connect” (and derivations thereof) are used to connote both direct and indirect connections/couplings. As another example, “having” and “including”, derivatives thereof and similar transitional terms or phrases are used synonymously with “comprising” (i.e., all are considered “open ended” terms)—only the phrases “consisting of” and “consisting essentially of” should be considered as “close ended”. Claims are not intended to be interpreted under 112 sixth paragraph unless the phrase “means for” and an associated function appear in a claim and the claim fails to recite sufficient structure to perform such function.

What is claimed is:

1. A method of detecting a missing nozzle used in an ink jet print head provided with plural chambers, plural heaters corresponding to the chambers, and plural nozzles corresponding to the heaters, comprising:
detecting a temperature of each of the chambers; and
when the detected temperature deviates from a predetermined temperature range, determining that the nozzle corresponding to the chamber is a missing nozzle.

2. The method according to claim 1, wherein the detecting uses a thin film thermocouple adjacent each of the chambers.

3. The method according to claim 1, wherein the predetermined temperature range is from 40° C. to 80° C.

4. The method according to claim 1, wherein the detecting is performed to detect a temperature of each of the chambers when the heaters are turned on.

5. An ink jet print head comprising:
a substrate formed with heaters and a passivation layer protecting the heaters;
a flow channel layer to define chambers corresponding to the heaters;
a nozzle layer formed with nozzles corresponding to the chambers;
temperature sensing parts to detect temperatures of the respective chambers; and
a control part to determine whether a missing nozzle is generated,
wherein when a temperature detected by a temperature sensing part deviates from a predetermined temperature range, the control part determines that a corresponding nozzle is a missing nozzle.

6. The ink jet print head according to claim 5, wherein the flow channel layer provides restrictors to guide the ink to the chambers, and the temperature sensing parts are provided in the restrictors.

7. The ink jet print head according to claim 5, wherein the temperature sensing parts are provided between the passivation layer and the flow channel layer, and adjacent to the chambers.

8. The ink jet print head according to claim 5, wherein the temperature sensing parts are configured as a thin film thermocouple.

9. An ink jet print head comprising:
plural nozzle modules that include chambers to hold ink, nozzles corresponding to the chambers, and heaters to heat the ink in the chambers;
temperature sensing parts provided in the respective nozzle modules to detect temperatures of the chambers; and
a control part to determine whether a missing nozzle is generated,
wherein when the detected temperature of the chamber deviates from a bubble generating temperature range of the ink, the control part determines that the nozzle of the corresponding nozzle module is a missing nozzle.

10. The ink jet print head according to claim 9, wherein the temperature sensing parts are configured as a thin film thermocouple.

11. The ink jet print head according to claim 9, wherein the control part controls an on/off state of the heaters, and the temperature sensing parts detect the temperatures of the chambers when the heaters are turned on.

12. A method of detecting a missing nozzle used in an ink jet print head, the method comprising:
measuring temperatures of each of a plurality of individual chambers of the ink jet print head separately; and
determining when the measured temperatures are out of a prescribed range.

13. The method according to claim 12, wherein the prescribed range is a bubble generating temperature range of liquid ink.

14. The method according to claim 12, further comprising:
providing heating units in a one-to-one correspondence with the nozzles; and
measuring temperatures of ink in a chamber corresponding to each nozzle when the ink jet print head is printing.

15. The method according to claim 14, wherein the measuring uses a thin film thermocouple corresponding to each of the chambers.

16. The method according to claim 12, wherein the detecting occurs during a printing operation or without a scanning operation.

17. A method of detecting a missing nozzle used in an ink jet print head, comprising:
detecting a single malfunctioning nozzle of a ink jet print head configured with a plurality of nozzles during a printing operation by independently measuring temperatures at a plurality of positions of the ink jet print head.

18. The method of claim 17, wherein the detecting a malfunctioning nozzle of the ink jet print head configured with the plurality of nozzles is performed by measuring temperatures of individual chambers of the ink jet print head.

19. The method of claim 18, wherein the individual nozzles are configured with a chamber and a heater corresponding to the chamber, wherein the detecting a missing nozzle comprises determining when a temperature of a single chamber is outside a prescribed temperature range.

20. An image forming apparatus including an ink jet print head comprising:
a plurality of nozzles; and
a plurality of detect circuits configured to determine temperature at a plurality of positions in the ink jet print head to identify a malfunctioning nozzle.

21. The image forming apparatus according to claim 20, wherein the plurality of detect circuits determine the temperature during a printing operation.

22. The image forming apparatus according to claim 21, wherein the ink jet print head comprises:
a substrate;
a plurality of heaters provided at the substrate;
a protection layer provided to cover the heaters;
a plurality chambers corresponding to the heaters;
said nozzles corresponding to the chambers;
temperature sensing parts to detect temperatures of the respective chambers; and
a control part to detect at least one deviated chamber temperature detected by a temperature sensing part relative to a predetermined temperature range, the malfunctioning nozzle to correspond to the detected deviated chamber temperature.

23. The image forming apparatus according to claim 21, wherein the predetermined temperature range is above a first value, below a second value, within a bubble generating temperature range of liquid ink.

24. The image forming apparatus according to claim 22, wherein the temperature sensing parts are thermocouples provided near and corresponding to each nozzle or near and corresponding to each chamber.
